(19) United States
(12) Patent Application Publication
(10) Pub. No.: US 2016/0028104 A1
(43) Pub. Date: Jan. 28, 2016

(54) ELECTROCHEMICALLY STABLE LI7P2S8I SUPERIONIC CONDUCTOR

(71) Applicant: UT-Battelle, LLC, Oak Ridge, TN (US)

(72) Inventors: Chengdu LIANG, Knoxville, TN (US); Ezhiylmurugan RANGASAMY, Oak Ridge, TN (US)

(21) Appl. No.: 14/719,791

(22) Filed: May 22, 2015

Related U.S. Application Data
(60) Provisional application No. 62/028,848, filed on Jul. 25, 2014.

(51) Int. Cl. H01M 10/0562; H01M 10/0525

(52) U.S. Cl. CPC H01M 10/0562; H01M 10/0525; H01M 2300/0068

(57) ABSTRACT

A Li₇P₂S₈I electrolyte for a battery is disclosed. The electrolyte can be a single phase of Li₇P₂S₈I. A battery having a Li₇P₂S₈I electrolyte is disclosed. A method of making a battery including a Li₇P₂S₈I electrolyte is also disclosed.

### CROSS REFERENCE TO RELATED APPLICATIONS

This application claims priority to U.S. Provisional Patent Application No. 62/028,848, filed Jul. 25, 2014, titled “ELECTROCHEMICALLY STABLE LI₇P₂S₈I SUPERIONIC CONDUCTOR,” the entire contents of which are incorporated herein by reference.

### STATEMENT REGARDING FEDERALLY SPONSORED RESEARCH

This invention was made with government support under contract No. DE-AC05-00OR22725 awarded by the U.S. Department of Energy. The government has certain rights in this invention.

### FIELD OF THE INVENTION

This invention relates generally to batteries, and more particularly to solid state electrolytes for Li battery technologies.

### BACKGROUND OF THE INVENTION

Solid-state electrolytes are quickly rising to prominence as useful components of advanced Li battery technologies due to their excellent electrochemical stability, favorable mechanical properties, and operation over a wide temperature window. Previous investigations have resulted in multiple solid-state Li-ion conductors that exhibit favorable characteristics for application in a full electrochemical cell. A Li₁₀GeP₂S₁₂ solid-state electrolyte has been reported with conductivity rivaling that of conventional liquid electrolytes. However, the presence of Ge makes it unstable with metallic Li anodes. Despite the number of promising candidates, very few systems have been demonstrated to be successful under a full electrochemical setup as a result of interfacial kinetic limitations and electrode—electrolyte compatibility issues.

High-energy batteries use metallic Li as anode and high-voltage materials as cathode. Therefore, it is critical to develop suitable solid electrolytes with high ionic conductivity and excellent chemical stability not only against the Li anode but also at higher voltages, to facilitate high-voltage cathodes and guard against cell abuse. While β-Li₃PS₄ and its composite Li-ion conductors have been reported to demonstrate the requisite characteristics, it forms a buffer layer with the Li anode to give the observed stability. Further improvements in conductivity, materials processability, and interfacial kinetics are also desired. Typically, sulfide-based ceramic electrolytes demonstrate ionic conductivity on the order of 10⁻³ S cm⁻¹ when synthesized in the form of solid solutions. However, the presence of electroactive substituents compromises the stability with Li anodes for these high-conduction systems. The use of non-electroactive species—alkali halides—has been reported to enhance ionic conductivity in Ag-based systems. Lithium halides, LiX (X═I, Cl, and Br), have been effectively utilized to stabilize the higher conduction phase in the LiBH₄ system while demonstrating excellent stability with metallic Li. LiX-based Li₆PS₅I and other halide derivatives have been developed with an argyrodite structure, with some systems demonstrating fast ion conduction. However, there is a lack of detailed investigations on their electrochemical stabilities and interfacial compatibilities. The Li₂S—P₂S₅ glassy phases have also been reported to form new conduction systems with alkaline halides. On account of the oxidation of the alkaline halides, these systems exhibit electrochemical instability in cyclic voltammetry investigations. In addition to that, the onset of reduction occurs before 0 V vs Li/Li⁺, suggesting that the electrolyte is not inherently stable with the Li anode.

### SUMMARY OF THE INVENTION

An electrolyte for a battery according to the invention comprises Li₇P₂S₈I. The electrolyte can consist essentially of Li₇P₂S₈I. The electrolyte can consist of Li₇P₂S₈I. The electrolyte can be a single phase of Li₇P₂S₈I. The electrolyte can comprise a solid solution of LiI in Li₃PS₄. The electrolyte can have the XRD pattern of 2Li₃PS₄:1 LiI in FIG. 1.

A battery according to the invention can have an anode comprising Li, a cathode, and an electrolyte comprising Li₇P₂S₈I, consisting essentially of Li₇P₂S₈I, or consisting of Li₇P₂S₈I. The electrolyte can be a single phase of Li₇P₂S₈I. The electrolyte of the battery can be considered a solid solution of LiI in Li₃PS₄. The anode of the battery can be at least one selected from the group consisting of Li, Si, SiO, Sn and SnO₂.

The cathode of the battery can include at least one selected from the group consisting of S, TiS₂, FeS₂, Fe₂S₂, Li₄PS₄₊ₙ (1<n<8), LiCoO₂, LiMn₂O₄, LiNi_{0.8}Co_{0.15}Al_{0.05}O₂, LiNi_{0.5}Mn_{1.5}O₄, and LiFePO₄.

A method of making the battery can include the steps of providing an anode comprising Li, providing a cathode, and interposing an electrolyte comprising Li₇P₂S₈I, consisting essentially of Li₇P₂S₈I, or consisting of Li₇P₂S₈I, between the anode and the cathode.

The electrolyte can be prepared by creating a solid solution of 2Li₃PS₄:1LiI. The solid solution can be prepared by the steps of mixing Li₃PS₄ and LiI and heating to at least 60° C.

### BRIEF DESCRIPTION OF THE DRAWINGS

There are shown in the drawings embodiments that are presently preferred it being understood that the invention is not limited to the arrangements and instrumentalities shown, wherein:

FIG. 1 is a plot of Relative Intensity/a.u. vs. 2θ/deg. for different stoichiometric compositions of Li₃PS₄ and LiI.

FIG. 2 is in Arrhenius plot of log σ/S cm⁻¹ vs. 1000 T⁻¹/K⁻¹ for Li₇P₂S₈I and LiPS₄.

FIG. 3 is ³¹P MAS (20 kHz) NMR spectra for the Li₇P₂S₈I phase.

FIG. 4 is a cyclic voltammogram for a Li/Li₇P₂S₈I/Pt cell at a scan rate of 1 mVs⁻¹.

FIG. 5 is a DC polarization curve for a Li/Li₇P₂S₈I/Li symmetric cell at a current density of 0.2 mA cm⁻².

FIG. 6 is a scanning electron microscopy (SEM) image (5 μm) of a surface of a warm pressed Li₇P₂S₈I membrane.

FIG. 7 is a scanning electron microscopy (SEM) image (5 μm) of a cross section of a warm pressed Li₇P₂S₈I membrane.

FIG. 8 are x-ray diffraction profiles for 2Li₃PS₄—LiI (Cu, Kα radiation) space group Pnma.

FIG. 9 is a plot of Relative Intensity/a.u. vs. 2θ/deg. for a 48 hour wash of Li₇P₂S₈I in acetonitrile (ACN).

FIG. 10 is a cyclic voltammogram for a 1:1 LiPS₄:LiI mixture.

FIG. 11 is a cyclic voltammogram for Li₇P₂S₈I.

FIG. 12 is a plot of Z″/Ωcm⁻² vs. Z′/Ωcm⁻² for a Li/Li₇P₂S₈I/Li symmetric cell.

FIG. 13 is a plot of voltage (V) vs. Step Time (s) individual cycle charge and discharge polarization curves for a Li/Li₇P₂S₈I/Li symmetric cell.

FIG. 14 is a scanning electron microscopy (SEM) image (20 μm) of a cross section of a warm pressed Li₇P₂S₈I membrane.

FIG. 15 is another scanning electron microscopy (SEM) image (20 μm) of a cross section of a warm pressed Li₇P₂S₈I membrane

### DETAILED DESCRIPTION OF THE INVENTION

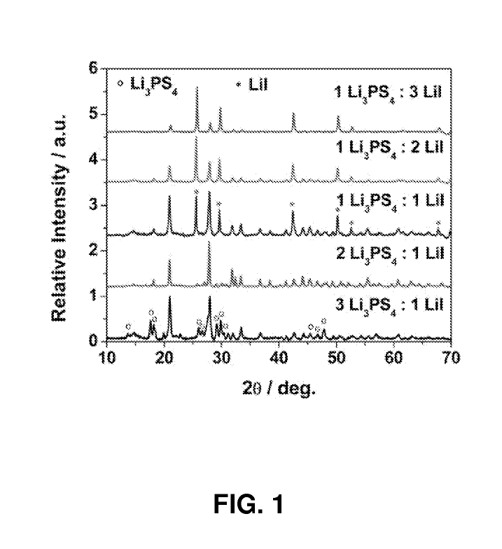

An electrolyte for a battery according to the invention comprises Li₇P₂S₈I. The electrolyte can consist essentially of Li₇P₂S₈I. The electrolyte can consist of Li₇P₂S₈I. The electrolyte can be a single phase of Li₇P₂S₈I. The electrolyte can comprise a solid solution of LiI in Li₃PS₄. The electrolyte can have the XRD pattern of 2Li₃PS₄:1LiI in FIG. 1.

A battery according to the invention can have an anode comprising Li, a cathode, and an electrolyte comprising Li₇P₂S₈I, consisting essentially of Li₇P₂S₈I, or consisting of Li₇P₂S₈I. The electrolyte can be a single phase of Li₇P₂S₈I. The electrolyte of the battery can be considered a solid solution of LiI in Li₃PS₄. The anode can include any suitable anode material. The anode can be at least one selected from the group consisting of Li, Si, SiO, Sn and SnO₂.

The cathode of the battery can be any suitable material. The cathode can include at least one selected from the group consisting of S, TiS₂, FeS₂, Fe₂S₂, Li₄PS₄₊ₙ (1<n<8), LiCoO₂, LiMn₂O₄, LiNi_{0.8}Co_{0.15}Al_{0.05}O₂, LiNi_{0.5}Mn_{1.5}O₄, and LiFePO₄.

A method of making the battery can include the steps of providing an anode comprising Li, providing a cathode, and interposing an electrolyte comprising Li₇P₂S₈I, consisting essentially of Li₇P₂S₈I, or consisting of Li₇P₂S₈I, between the anode and the cathode.

The electrolyte can be prepared by creating a solid solution of 2Li₃PS₄:1LiI. The solid solution can be prepared by the steps of mixing Li₃PS₄ and LiI and heating to at least 60° C.

Various stoichiometric compositions of LPS and LiI were mixed and heat-treated at 200° C. Li₃PS₄ was synthesized using Li₂S (Alfa Aesar—99.9%) and P₂S₅ (Sigma Aldrich—99%) mixed stoichiometrically in a 2:1 ratio (excess P₂S₅ was used) in Acetonitrile (Sigma Aldrich—99.8% anhydrous) for 24 hrs. The resulting powders are treated at 80° C. to remove excess acetonitrile (ACN) yielding Li₃PS₄.2ACN. The Li₃PS₄.2ACN is further dispersed in acetonitrile containing the requisite amount of LiI and mixed in a turbulent mixer for 15 minutes. The resulting slurry is dried ambiently for 12 hours and treated in vacuum at 200° C. to obtain the solid solution. On account of the sensitivity to O₂ and moisture for the system, all the experimental procedures are carried out in a glove box with <0.1 ppm of O₂ and H₂O.

Crystallographic phase identification was conducted by using a PANalytical X'Pert Pro Powder Diffractometer with Cu Kα radiation. XRD samples were prepared in a glove box with Ar atmosphere. Kapton® films were used to seal quartz slides to exclude air contact. Qualitative analyses were conducted by the software of HighScore Plus, which is developed by PANalytical. Scanning Electron Microscopy (SEM) characterizations were conducted utilizing environment sensitive sample holders in a MERLIN Field Emission Scanning Electron Microscope (FE-SEM) from Carl Zeiss. Electrochemical Impedance Spectroscopy (EIS) measurements were conducted using a 1260 Solartron Frequency Response Analyzer between 1 MHz and 0.1 Hz at the amplitude of 100 mV. Carbon coated Al-foils were used as blocking electrodes. Pellets for the symmetric cells and cyclic voltammetry studies were cold pressed at 320 Mpa and Li foils (⅜″ diameter and ≈100 μm thick) were attached to them after cold pressing. Cyclic voltammetry investigations were conducted using a Bio-logic VSP multi-channel potentiostat using a scan rate of 1 mV s⁻¹. Samples were packed in 3.2 mm MAS rotors in an Argon-filled glove box. MAS NMR experiments were performed with a 7.05 T Varian-S Direct Drive Wide Bore spectrometer and a 3.2 mm MAS probe operating at 122.0 MHz and 60.3 MHz to study ³¹P and ¹²⁷I respectively. A 20 kHz MAS speed was used. ³¹P single-pulse experiments were run with a 3.1 μs π/2 pulse length, a 600 s recycle delay and 128 transients. ³¹P chemical shifts are referenced to 85% H₃PO₄ aqueous solution (δ=0 ppm). ¹²⁷I rotor-synchronized solid-echo experiments (π/2 pulse−τ−π/2 pulse−τ−acquire) were run with a 2 μs π/2 pulse length, a 0.5 s recycle delay and 130,000 transients.

The presence of an excess of either of the precursors resulted in precipitation of the respective phase in addition to the newly formed phase (FIG. 1). FIG. 1 is a plot of Relative Intensity/a.u. vs. 2θ/deg. for different stoichiometric compositions of Li₃PS₄ and LiI. The maximum phase purity was observed at a 2:1 ratio of Li₃PS₄:LiI precursors, with no observed reflections from the parent systems. An excess of either phase results in that phase being a secondary impurity in addition to the Li₇P₂S₈I phase.

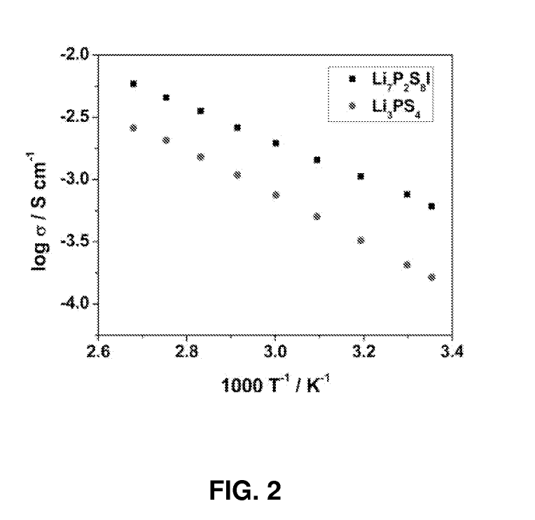

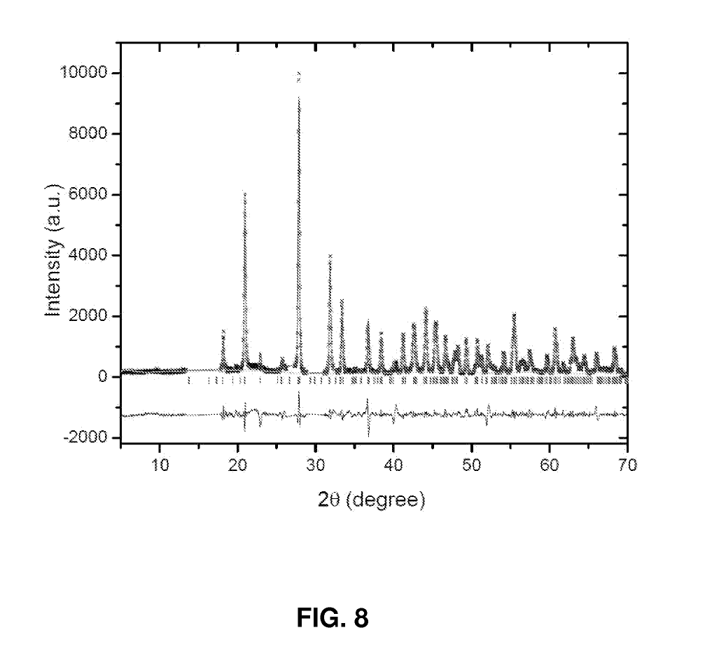

The invention incorporates LiI into a solid-state Li-ion conductor while simultaneously eliminating the inherent oxidation of LiI and its low ionic conductivity. The appropriate compositions of LiI and Li₃PS₄ create a new phase which exhibits an electrochemical stability of 10 V vs Li/Li⁺ while its room-temperature ionic conductivity is simultaneously enhanced to 6.3×10⁻⁴ S cm⁻¹ (FIG. 2). FIG. 2 is in Arrhenius plot of log σ/S cm⁻¹ vs. 1000 T⁻¹/K⁻¹ for Li₇P₂S₈I and LiPS₄. This is more than 400% higher than that of β-Li₃PS₄ and more than 3 orders of magnitude higher than that of LiI. The new phase has very good compatibility with metallic Li anode. A Le Bail refinement (FIG. 8) of the 2:1 composition revealed a single phase indexed to a Pnma space group, similar to the β-Li₃PS₄. FIG. 8 illustrates experimental (markers), Le Bail fitted (line), and difference (line below observed and calculated patterns) XRD profiles for 2Li₃PS₄—LiI (Cu Kα radiation), space group Pnma. The vertical bars indicate the calculated positions of Bragg peaks. Goodness of fit: Rwp=14.6%, Rp=10.2%, X2=3.92. Regions with noticeable diffraction peaks from the precursor impurity phases were excluded in the data fit. The refined lattice parameters for space group Pnma are: a=12.703(1)A, b=8.4458(9)A, and c=5.9421(5)A. Le Bail profile refinements were performed using the GSAS package on the XRD data. Excellent fits were obtained, proving that the new phase is indeed a single phase formed as a result of the following reaction:

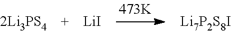

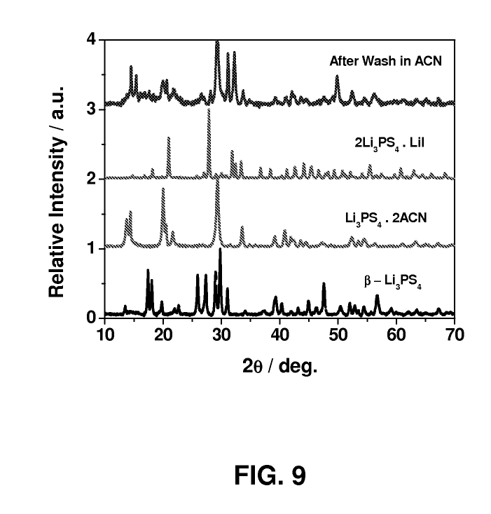

When the resultant phase was dispersed in acetonitrile and subsequently dried at 80° C., LiI dissolved in the solvent and was lost during the solvent removal. FIG. 9 is a plot of Relative Intensity/a.u. vs. 2θ/deg. for a 48 hour wash of Li₇P₂S₈I in acetonitrile (ACN). The XRD analysis of the powders showed the presence of Li₃PS₄.2ACN and partial presence of crystalline Li₃PS₄ along with an unknown phase. With the similarity in the crystal structures and the ability to extract LiI from the Li₇P₂S₈I, this newly formed phase is attributed to a solid solution of LiI in Li₃PS₄.

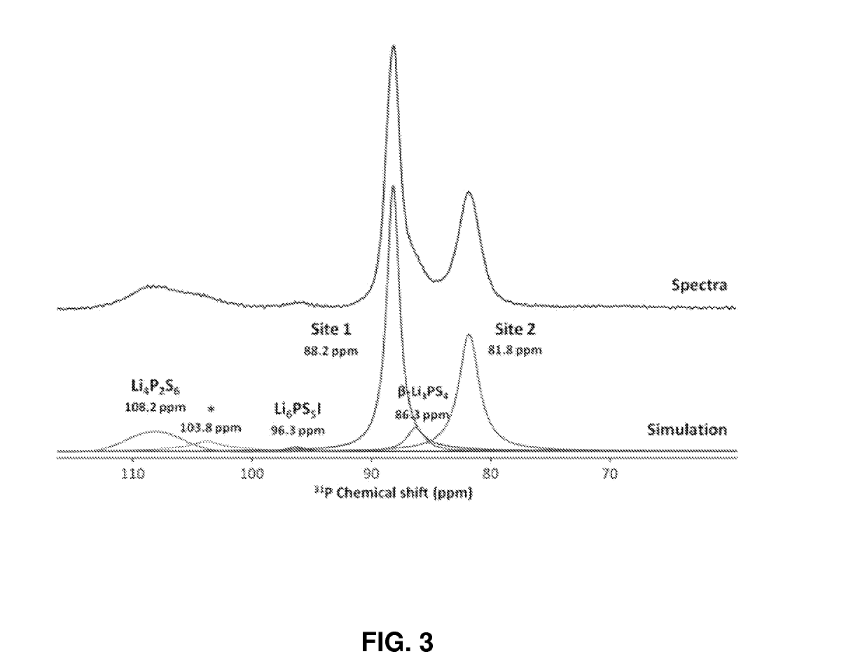

NMR spectroscopic characterization of the newly synthesized phase confirmed the formation of new chemical sites. FIG. 3 is ³¹P MAS (20 kHz) NMR spectra for the Li₇P₂S₈I phase. The ³¹P NMR spectrum (FIG. 3) revealed two major distinct peaks in the chemical shift range of isolated PS₄³⁻ tetrahedra, supporting the presence of two coordination sites in Li₇P₂S₈I, one conforming to γ-Li₃PS₄ (88.2 ppm) and the second attributed to a PS₄³⁻ tetrahedron with I atoms in the secondary coordination shell (81.8 ppm). Very minor residual β-Li₃PS₄ is also observed in the NMR, in addition to Li₄P₂S₆, Li₆PS₅I, and an unknown phase.

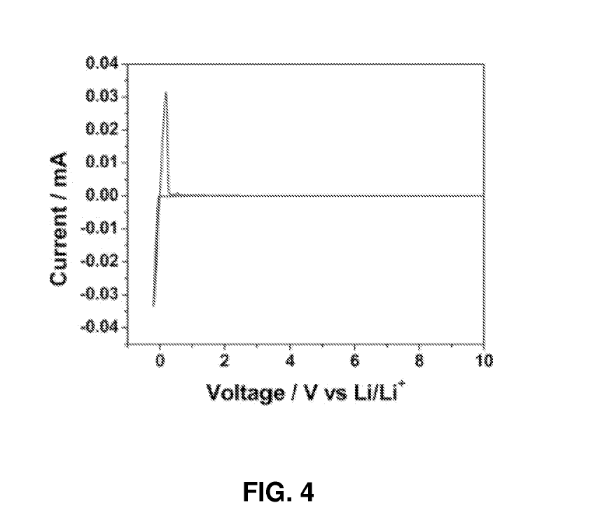

Dramatic reactions as a result of overcharging in conventional Li-ion cells are well documented. The surge in cell temperature resulting from the cathodic reactions has also been proposed to result in chemical reactions at the anode that complicate cell safety under such conditions. Hence, anodic stability coupled with cathodic stability (i.e., electrochemical stability of the electrolyte), high ionic conductivity, increased temperature stability, and lack of flammability is identified as a vital criterion for next-generation Li-ion cells. FIG. 4 is a cyclic voltammogram for a Li/Li₇P₂S₈I/Pt cell at a scan rate of 1 mVs⁻¹. The cyclic voltammetry investigation of the Li₇P₂S₈I electrolyte exhibited electrochemical stability of up to 10 V vs Li/Li⁺ under the measured conditions. The observed electrochemical stability is higher than that of the state-of-the-art garnet electrolytes (9 V vs Li/Li⁺) and typical sulfide electrolytes (5 V vs Li/Li⁺) and on par (10 V vs Li/Li⁺) with an earlier report on oxysulfide glasses. The multiple minor oxidation peaks observed between 0.42 and 0.7 V are attributed to the anodic reactions forming the Pt—Li alloy at the Pt working electrode. The stability of the newly synthesized phase at the oxidative potentials is attributed to the coordination of I within the structure. This result differs from earlier reports with Li₂S—P₂S₅—LiI systems that exhibit minor oxidation of LiI and reduction prior to 0 V. The presence of a high-purity Li₇P₂S₈I phase thus eliminates the instabilities of Li₃PS₄ and LiI.

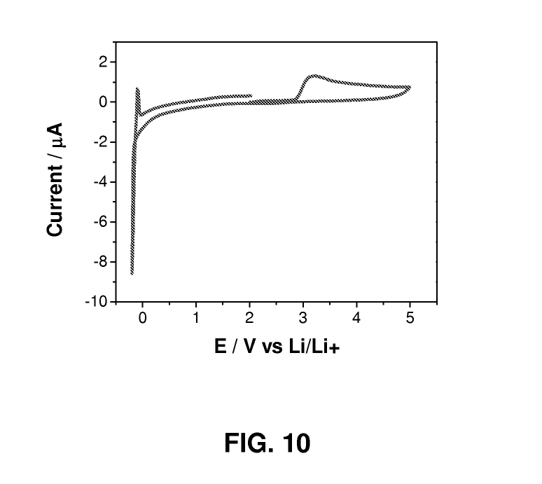

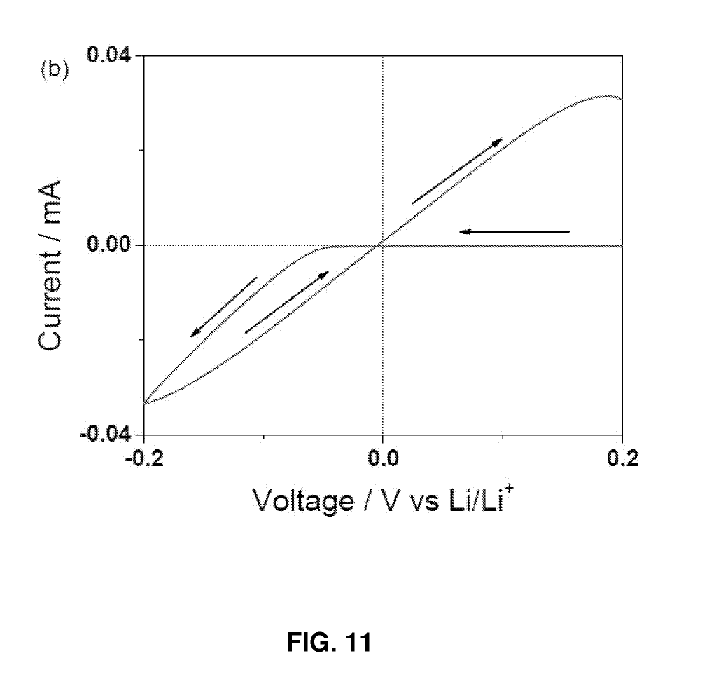

A control sample prepared with excess LiI (FIG. 10) illustrated that the excess LiI undergoes oxidation at 3.2 V vs Li/Li⁺. This is in contrast to the electrochemical stability of the newly formed phase. The cyclic voltammogram of FIG. 10 for a 1:1Li₃PS₄:LiI mixture illustrates the oxidation of the excess LiI and also the lack of anodic stability (onset of reduction prior to 0 V vs Li/Li+) which is in contrast to the Li₇P₂S₈I phase that is stable at the anodic and cathodic cycles of CV. The reduction and oxidation of Li is shown in FIG. 11. The onset of reduction occurs only beyond 0 V vs Li/Li+ illustrating the stability for the newly formed phase with the Li anode. The included arrows illustrate the direction of the CV scan. The cathodic reaction occurs only beyond 0 V vs Li/Li⁺. Systems that are typically electroactive with metallic Li or form passive interfaces exhibit onset of a cathodic current before 0 V. This confirms the stability for the electrolyte with Li anode.

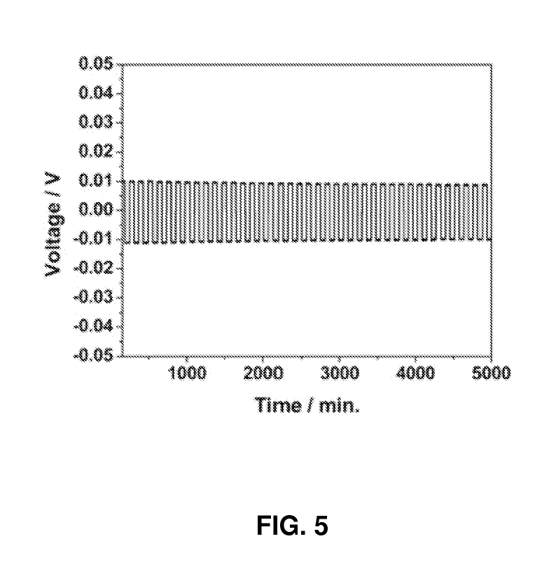

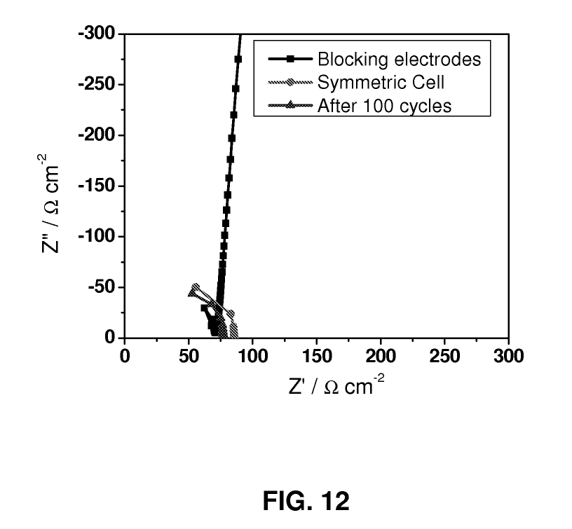

Symmetric Li/Li₇P₂S₈I/Li cells were fabricated and cycled at ambient conditions (FIG. 5), exhibiting polarization significantly lower than that of the LPS electrolyte or its composites. FIG. 5 is a DC polarization curve for a Li/Li₇P₂S₈I/Li symmetric cell at a current density of 0.2 mA cm⁻². Calculating DC cell conductivity from the polarization yields a value of 5.8×10⁻⁴ S cm⁻¹, similar to the AC measurement of 6.3×10⁻⁴ S cm⁻¹ under a blocking configuration. The lack of difference between total cell conductivity and bulk electrolyte conductivity is evidence of the low charge-transfer resistance (FIG. 12). FIG. 12 is a plot of Z″/Ωcm⁻² vs. Z′/Ωcm⁻² for a Li/Li₇P₂S₈I/Li symmetric cell. The excellent interfacial kinetics is manifested in the close proximity for the EIS measurements conducted in a blocking configuration and for the Li/Li₇P₂S₈I/Li symmetric cells. The reduction of the cell resistance immediately before cycling and after the completion of 100 cycles is the resultant of a homogenous Li layer formed during the cycling process.

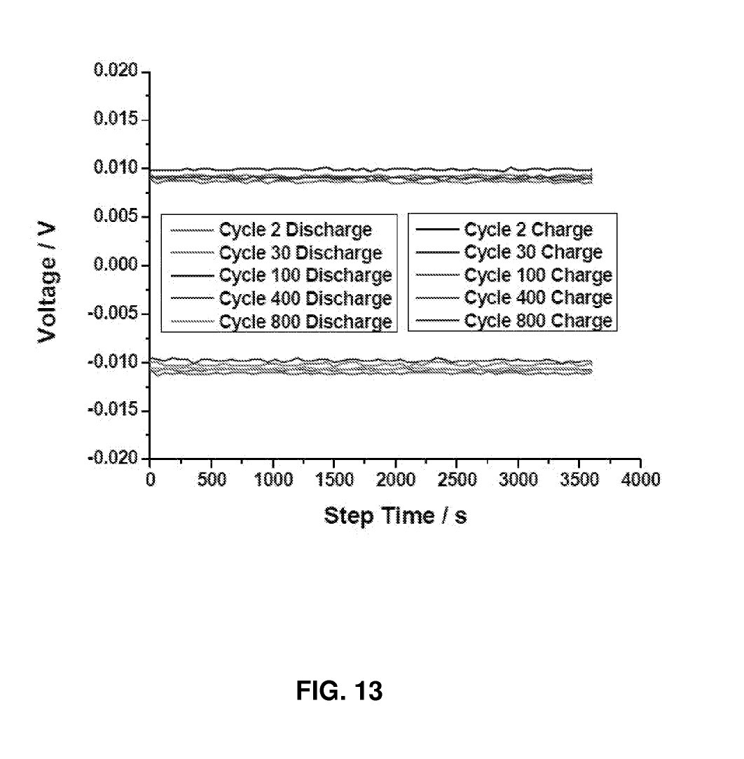

FIG. 13 is a plot of voltage (V) vs. Step Time (s) individual cycle charge and discharge polarization curves for a Li/Li₇P₂S₈I/Li symmetric cell. Due to the nature of cell assembly (physically attached Li electrodes), the interfacial resistance reduces with cycling until a homogeneous Li layer is formed. The polarization remains constant after the formation cycles, wherein cycle numbers 30, 100, 400, and 800 overlap one another. The cell was cycled over 800 times, demonstrating an excellent Li cycle life. FIG. 13 illustrates individual cycle charge and discharge polarization curves for the Li/L₇P₂S₈I/Li cell indicating the uniform polarization as a function of cycle number even after multiple hundreds of cycles. A minor reduction (≈5%) in polarization is observed between cycles 1-5 and subsequent cycles. This can be attributed to the establishment of a homogenous Li layer at the Li—Li₇P₂S₈I interface.

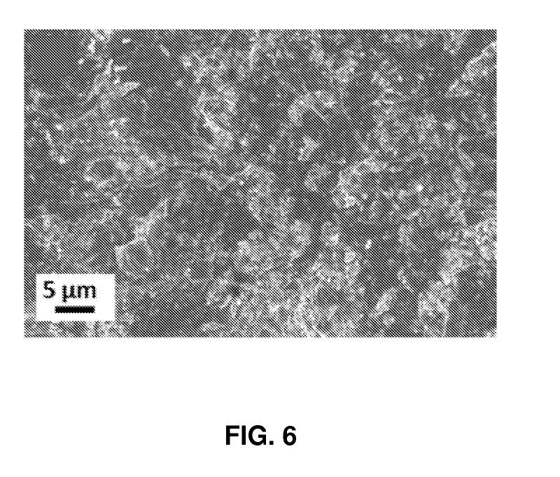

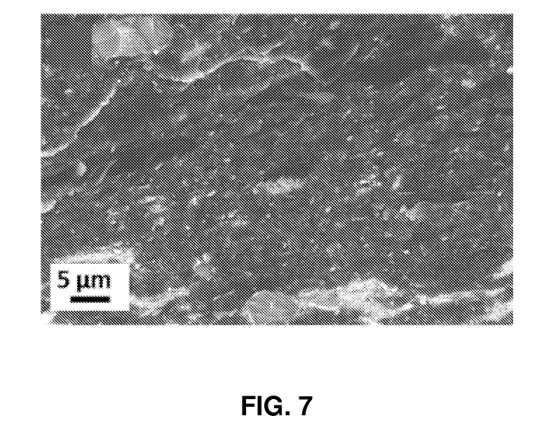

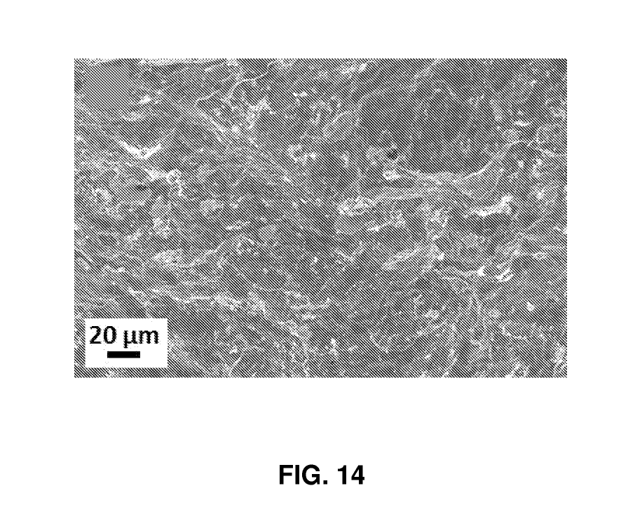

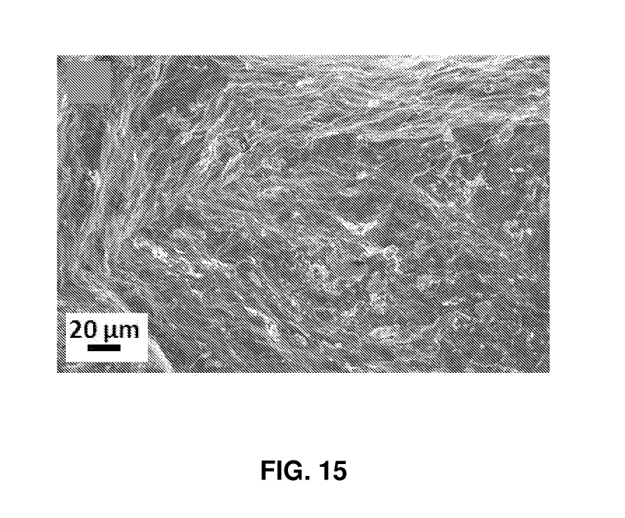

The Li₇P₂S₈I electrolyte facilitates membrane densification via warm pressing. Li-ion conduction in a ceramic electrolyte happens in the solid phase, it is therefore important that the membrane be devoid of any pores/voids. One of the major drawbacks of the oxide-based Li-ion conductors is the requirement of high temperatures (>1000° C.) for the densification of membranes. Thus, membrane processability at ambient temperatures or relatively warm temperatures (<300° C.) is critical. The membranes are pressed at 320 MPa and 270° C., resulting in dense electrolyte membranes with no observed porosity. This is shown in the SEM images of a warm pressed Li₇P₂S₈I, such as the surface image of FIG. 6 and the cross section of FIG. 7, which illustrate a highly dense network with no observed voids. Earlier reports have demonstrated similar densification with the glassy sulfides. The fracturing morphology confirms the occurrence of densification via sintering. There is shown in FIGS. 14-15 SEM images of the cross section of a Li₇P₂S₈I membrane warm pressed at 270° C. The fracture morphology confirms the densification during the warm press procedure, and illustrates the lack of voids and pores and the effectiveness of the densification. Such a low-temperature-based densification enables the possibility of membrane reinforcement using stable polymeric additives. This could be the key to obtaining flexible solid-state Li-ion conductors that are suitable for industrial-scale processing.

The invention provides a new Li₇P₂S₈I phase that exhibits the characteristics of a solid solution between Li₃PS₄ and LiI with fast ion conduction and electrochemical stability up to 10 V vs Li/Li⁺. The presence of I enhances the stability of the electrolyte with metallic Li anode while demonstrating low charge-transfer resistance. These characteristics form a foundation that allows the electrolyte to exhibit excellent cycle life and stability at ambient conditions. The material property of the electrolyte allows low-temperature densification and enhanced processability, which is vital to developing industrial-scale solid electrolyte membranes.

Ranges: throughout this disclosure, various aspects of the invention can be presented in a range format. It should be understood that the description in the range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range for example, 1, 2, 2.7, 3, 4, 5, 5.3 and 6. This applies regardless of the bread of the range.

This invention can be embodied in other forms without departing from the spirit or essential attributes thereof, and accordingly, reference should be had to the following claims to determine the scope of the invention.

We claim:

1. An electrolyte for a battery, comprising Li₇P₂S₈I.

2. The electrolyte of claim 1, wherein said electrolyte consists essentially of Li₇P₂S₈I.

3. The electrolyte of claim 1, wherein said electrolyte consists of Li₇P₂S₈I.

4. The electrolyte of claim 1, wherein said electrolyte comprises a single phase of Li₇P₂S₈I.

5. The electrolyte of claim 1, wherein said electrolyte has the XRD pattern of 2Li₃PS₄:1LiI in FIG. 1.

6. The electrolyte of claim 1, wherein the electrolyte comprises a solid solution of LiI in Li₃PS₄.

7. A battery, comprising:
an anode comprising Li;
a cathode; and,
an electrolyte comprising Li₇P₂S₈I.

8. The battery of claim 7, wherein said electrolyte consists essentially of Li₇P₂S₈I.

9. The battery of claim 7, wherein said electrolyte consists of Li₇P₂S₈I.

10. The battery of claim 7, wherein said electrolyte comprises a single phase of Li₇P₂S₈I.

11. The battery of claim 7, wherein said electrolyte has the XRD pattern of 2Li₃PS₄:1LiI in FIG. 1.

12. The battery of claim 7, wherein the electrolyte comprises a solid solution of LiI in Li₃PS₄.

13. The battery of claim 7, wherein the anode comprises at least one selected from the group consisting of Li, Si, SiO, Sn and SnO₂.

14. The battery of claim 7, wherein the cathode comprises at least one selected from the group consisting of S, TiS₂, FeS₂, Fe₂S₂, Li₄PS₄₊ₙ (1<n<8), LiCoO₂, LiMn₂O₄, LiNi_{0.8}Co_{0.15}Al_{0.05}O₂, LiNi_{0.5}Mn_{1.5}O₄, and LiFePO₄.

15. A method of making a battery, comprising the steps of:
providing an anode comprising Li;
providing a cathode;
interposing an electrolyte between the anode and the cathode, the electrolyte comprising Li₇P₂S₈I.

16. The method of claim 15, wherein the electrolyte is prepared by creating a solid solution of 2Li₃PS₄:1LiI.

17. The method of claim 16, wherein the solid solution is prepared comprising the steps of mixing Li₃PS₄ and LiI and heating to at least 60° C.
